(19) United States
(12) Patent Application Publication
(10) Pub. No.: US 2026/0033464 A1
(43) Pub. Date: Feb. 5, 2026

(54) CONSTRUCTION METHOD OF MARICULTURE NET CAGE FLOATING BODY BASED ON COMBINATION OF CEMENT BLANKET AND ECC

(71) Applicant: SANYA SCIENCE AND EDUCATION INNOVATION PARK OF WUHAN UNIVERSITY OF TECHNOLOGY, SANYA (CN)

(72) Inventors: ZHONGHE SHUI, SANYA (CN); XIBO QI, SANYA (CN)

(21) Appl. No.: 19/355,660

(22) Filed: Oct. 10, 2025

Related U.S. Application Data
(63) Continuation of application No. PCT/CN2025/088691, filed on Apr. 14, 2025.

(30) Foreign Application Priority Data
May 13, 2024 (CN) 202410585919.5

(51) Int. Cl. A01K 61/60

(52) U.S. Cl. CPC A01K 61/60

(57) ABSTRACT

The present disclosure provides a construction method of a mariculture net cage floating body based on a combination of cement blanket and ECC that includes: step S1, using floating materials to build a net cage floating frame, wrapping around the net cage floating frame with cement blanket, and then spraying water onto surfaces of the net cage floating frame to enable cement in the cement blanket to generate hydration reaction, to obtain a substrate of the net cage floating body; step S2, wrapping a continuous three-dimensional fabric around an outer surface the substrate of the net cage floating body, and then applying or spraying chopped fiber reinforced cement slurry on surfaces of the wrapped continuous three-dimensional fabric. After the chopped fiber reinforced cement slurry is solidified, polishing surfaces of the net cage floating body and then applying a multifunctional marine protective coating.

### CROSS-REFERENCE TO RELATED APPLICATION

The present disclosure is a continuation application of International application No. PCT/CN2025/088691, filed on Apr. 14, 2025, which claims priority to Chinese Patent Application No. 202410585919.5 filed on May 13, 2024 with the Chinese Patent Office, the disclosures of which are incorporated herein by reference in their entireties.

### TECHNICAL FIELD

The present disclosure relates to the field of marine aquaculture technologies, and especially relates to a construction method of a mariculture net cage floating body based on a combination of cement blanket and ECC.

### BACKGROUND

An ordinary net cage is consisted of a plurality of parts that includes a net cage floating body (a main structure), a net cover, a ballast, a cable and a guardrail, etc. The net cage floating body is shown in a black part at the top of FIG. 1. The net cage floating body is a main component of a floating net cage, which is a platform that provides buoyancy and functional support for the net cage. The floating body is mostly composed of a cylindrical, a polyhedral and other components to form circular, square circular and polygonal floating structures. The net cage facilities such as the net covers are hung and fixed on the floating body in a certain way.

With the rapid development of the marine aquaculture industry, the demand for marine net cages is also increasing. At present, the net cage floating body that is commonly used for marine fish culture includes a steel net cage floating body and a PE plastic net cage floating body. Although the steel net cage is sturdy, it is expensive, prone to being rusted and has a high maintenance cost thereof. While the PE plastic net cage is not expensive, but its ability to resist wind and waves is limited, prone to being deformed, and often causes great losses when encountering strong winds and waves. The PE plastic net cage is also under an action of ultraviolet rays, resulting in a short service life and being unfavorable to marine environments. Therefore, exploring new functions of new materials and developing a new net cage floating body with a low-cost, durable, strong ability to resist wind and waves, and easy to be maintained has become an important demand in the industry.

Cement blanket is a new type of building material, which is a roll product that is taken three-dimensional fiber fabric as a skeleton, filled with powder of cementitious materials such as cement, and is solidified and hardened when encountering water. At present, the cement blanket has been widely used in a pond, a slope, and ditch management and protection projects, but it has not yet been to use the cement blanket to construct marine ranch facilities, such as structural components that are taken as aquaculture cages.

### SUMMARY

The technical problems to be solved: in view of the short comings of the related art, the present disclosure provides an improved construction method of a mariculture net cage floating body based on a combination of cement blanket and ECC which can provide the cement blanket as a main structural material to combine with ECC, to make a composite floating structure have dual characteristics of toughness and toughness, make the aquaculture net cage have higher stability and stronger ability to resist wind and waves, and effectively enhance a corrosion resistance and a service life thereof.

The ECC of the present disclosure is referred to a chopped fiber reinforced cement slurry.

The technical solution adopted for solving technical problems of the present disclosure is implemented as follows:
a construction method of a mariculture net cage floating body based on a combination of cement blanket and ECC includes the following steps:
step S1, combining cement blanket with a floating material to build a net cage floating frame, sealing internal and external connections of the cement blanket by adopting waterproof sealant, and then spraying water on surfaces of the net cage floating frame to enable cement in the cement blanket to generate hydration reaction, to obtain a substrate of the net cage floating body; and
step S2, wrapping continuous three-dimensional fabric around an outer surface of the substrate of the net cage floating body that is obtained in the step S1, and then applying or spraying chopped fiber reinforced cement slurry on surfaces of the wrapped continuous three-dimensional fabric, wherein after the chopped fiber reinforced cement slurry is solidified, polishing the surface of the net cage floating body and then applying multifunctional marine protective coating, to obtain the marine aquaculture net cage floating body based on the combination of cement blanket and ECC.

Wherein the floating material is selected from one of a PVC pipe, a bamboo, a wood and a rubber airbag, and the waterproof sealant is a silicone waterproof sealant.

The floating material of the present disclosure is selected from the PVC pipe, the bamboo, the wood and the rubber airbag, which is lightweight, cheap, widely available and has certain strength and stiffness.

Wherein the net cage floating frame is a shape that is selected from one of circular, square, elliptical, triangular and polygonal.

Wherein a thickness of the cement blanket is 10-20 mm, a plurality of layers of cement blanket is used to wrap the net cage floating frame, and then a waterproof adhesive is used to bond between the layers of the cement blanket.

Wherein a thickness of the net cage floating frame that is wrapped by the cement blanket is 10-20 mm.

Wherein the waterproof adhesive is selected from one of a polyurethane waterproof adhesive, an acrylic waterproof adhesive and an epoxy resin waterproof adhesive.

Wherein an amount that water is sprayed during a spraying process is based on that the cement blanket is fully wet on the surfaces of the net cage floating frame, the water is sprayed twice or more times, and an amount of water that is sprayed is 25% to 35% of the cement that is filled in the cement blanket.

Wherein a thickness of the continuous three-dimensional fabric is 3-10 mm, wherein the continuous three-dimensional fabric is wrapped around the substrate of the net cage floating body through a winding way, so that a covering layer that is formed by the continuous three-dimensional fabric is tightly bonded to the outer surface of the substrate of the net cage floating body, and there is an overlap width of 10-20 mm between adjacent wrapping layers of the continuous three-dimensional fabric.

Wherein a thickness of the continuous three-dimensional fabric that is formed on the outer surface of the substrate of the net cage floating body is 3-10 mm.

Wherein the chopped fiber reinforced cement slurry is prepared from the following weight parts of raw materials: 40-60 parts of portland cement, 15-25 parts of slag powder, 25-35 parts of fly ash, 60-80 parts of river sand, 1-3 parts of dihydrate gypsum, 1-3 parts of polycarboxylate superplasticizer, 1-4 parts of chopped fibers, and 20-40 parts of water.

Wherein a thickness that is formed by applying or spraying the chopped fiber reinforced cement slurry is 2-5 mm.

Wherein a preparation method of the chopped fiber reinforced cement slurry is to add the portland cement, the slag powder, the fly ash, the river sand, the dihydrate gypsum, the polycarboxylate superplasticizer, and the chopped fibers to water, and then stir and mix evenly to obtain the chopped fiber reinforced cement slurry.

Wherein the chopped fibers comprise one or more of PVA fiber, PE fiber and basalt fiber, a length of the chopped fiber is 12-15 mm, the portland cement is P.I Portland cement, the fly ash is first-class fly ash, and a particle size of the river sand is smaller than or equal to 1.25 mm.

Wherein after being polished, the surfaces of the net cage floating body are basically flat, without adhesive scars or sharp protrusions.

Wherein a thickness of the multifunctional marine protective coating that is applied to the surface of the net cage floating body is 2-4 mm.

Wherein the multifunctional marine protective coating is selected from one or more of ZS-533 marine anti-biological adhesion coating, organic silicon anti-seepage coating, and silicate polymer coating.

The present disclosure, compared with the related art, provides the advantages as below:

The cement blanket is a directional and shaped fiber reinforced cement-based composite material that is formed by filling the cementitious material such as cement into the three-dimensional fabric. The present disclosure uses a composite of the cement blanket and the chopped fiber reinforced cement slurry (ECC) with excellent strength and toughness as a structural material to construct the mariculture net cage floating body. The cement blanket can be cut, curled and folded etc. before being solidified. When water is evenly poured on the cement blanket, the cement within the cement blanket can be quickly solidified and hardened, so that the entire three-dimensional fabric inside the cement blanket is solidified into a very tough and strong spatial surface, thereby forming a strong and dense substrate of the net cage floating body between the cement blanket and the floating body material. And then, on the basis of the substrate of the net cage floating body, a main structure of the entire net cage floating body is wrapped with a thin layer of three-dimensional fabric (preferably using a winding way), and then covered with the chopped fiber reinforced cement slurry by a coating or spraying way on the three-dimensional fabric, which is equivalent to covering the structure with a layer of continuous fiber ECC and a layer of chopped fiber ECC, such composite structure that is composed of the cement blanket and ECC combines three different materials with different characteristics together, thereby ensuring both mechanical properties and anti-seepage sealing performances of the net cage floating body, effectively enhancing the ability to resist wind and waves. In addition, a mesh of the three-dimensional fabric is taken as a filter to allow the cement slurry to enter the three-dimensional fabric, while blocking most of the fibers in a surface layer thereof, resulting in forming a hard and flexible surface layer that is rich in microfibers, and effectively improving performances of the net cage floating body.

The chopped fiber reinforced cement slurry of the present disclosure is applied or sprayed on the three-dimensional fabric to form an outer shell thereof. At this time, in order to squeeze a sufficient amount of cement slurry into gaps of the three-dimensional fabric, it is necessary to control a fiber content of the chopped fiber reinforced cement slurry, and a weight percentage should be preferably controlled at about 0.5% to 2%. After the cement slurry within the chopped fiber reinforced cement slurry enters the three-dimensional fabric, the fibers on surfaces are aggregated and concentrated, to form a ECC surface layer that is a dense, hard and flexible chopped fiber, thereby effectively improving compactness, stiffness and toughness of the net cage floating body, and making the net cage floating body have higher stability and stronger ability to resist wind and waves.

The mariculture net cage floating body of the present disclosure is conveniently constructed and a construction cost is low: the cement blanket is taken as the main structural material, and a main operating process is cutting, curling, sewing and sealing, etc., thereby avoiding a tedious process that a conventional prefabricated component is to supporting, molding, pouring, vibration and maintenance. The cement blanket is a product that is widely produced and applied, which has a mature application technology and a low manufacturing cost thereof.

The mariculture net cage floating body of the present disclosure is easy to be maintained and a maintenance cost is low, and this net cage structure with the cement-based material does not have corrosion problems, so there is no need for performing rust removal operations. When marine organisms such as barnacles and algae, are attached to the mariculture net cage floating body, they can be removed in situ at a work site thereof. When the net cage floating body is partially damaged, the cement-based material can be easily used for performing on-site repair on the net cage floating body, and even divers can perform local repairs on underwater structures. The maintenance cost of the net cage structure is much lower than that of steel and plastic net cages.

The mariculture net cage floating body of the present disclosure has strong ability to resist wind and waves. The composite floating body that is combined with the cement blanket and ECC has dual characteristics of strength and toughness, strong abilities to resist to wind and waves, and debris impacts. Moreover, its structural deadweight is more than three times that of the PE net cage floating body under the same bearing capacity conditions, the net cage has higher stability and stronger ability to resist wind and waves.

The mariculture net cage floating body of the present disclosure has a long service life: a combination of the fibers and the cement substrate is to form a reinforcing and toughening effect. The cement blanket is overlaid with the continuous three-dimensional fabric and the chopped fiber reinforced cement slurry (ECC) to form a multi-layer composite material, which improves stiffness, toughness and sealing performances of the overall structure, and also enhances the service life thereof.

The mariculture net cage floating body of the present disclosure has a wide range of applications: the material and the technology can be applied to structural strengthening and reinforcement, corrosion protection of various marine devices that are steel structures, plastic structures and composite material structures thereof.

Raw materials of the cement blanket are widely available, with good corrosion resistance, and excellent durability and environmental friendliness in marine environments. The present disclosure utilizes the above characteristics of the cement blanket to produce the net cage floating body with a specific shape through cutting, curling, splicing, sewing and other operations. And then, water is sprayed quantitatively and evenly to solidify and shape the cement blanket, thereby successfully building a basic structure of the cement blanket net cage floating body, which makes the net cage floating body have higher stability and stronger ability to resist wind and waves, as well as a long corrosion resistance and a long service life.

### BRIEF DESCRIPTION OF THE DRAWINGS

FIG. 1 is a schematic view of an overall structure of a cage that is commonly used for marine aquaculture.

FIG. 2 is a cross-sectional view of a pipe of a square marine aquaculture net cage floating body combined with cement blanket and ECC in accordance with a first embodiment of the present disclosure.

FIG. 3 is a schematic view of the square marine aquaculture net cage floating body combined with cement blanket and ECC in accordance with the first embodiment of the present disclosure.

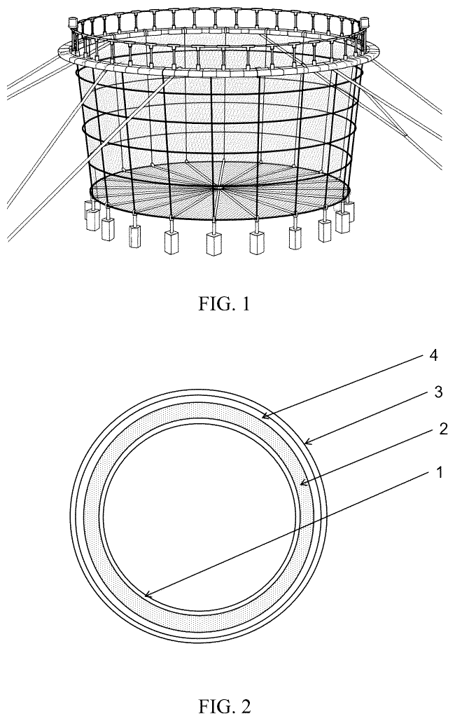

The element labels according to the embodiment of the present disclosure shown as below:
1 PVC pipe, 2 cement blanket layer, 3 three-dimensional fabric layer, 4 chopped fiber reinforced cement slurry layer, 5 steel wire mesh, 6 waterproof sealing connection corner of cement blanket.

### DETAILED DESCRIPTION

In order to more clearly understand the technical solution of the present disclosure, references will now be made in detail to embodiments, examples of which are illustrated in the accompanying drawings.

Unless otherwise specified, experimental methods that are used in the embodiments of the present disclosure are conventional methods.

Unless otherwise specified, materials and reagents, etc. that are used in the embodiments of the present disclosure can be obtained from commercial sources.

Manufacturer information of waterproof sealant, waterproof adhesive, multifunctional marine protective coating and cement blanket that are used in the embodiments of the present disclosure is as follows:

| Raw material name | | Manufacturer information |
|---|---|---|
| Waterproof | Silicone | Manufacturer: Zhejiang Hejun New |
| sealant | waterproof | Material Technology Co., Ltd., |
| | sealant | Name: Neutral Silicone Structural |
| | | Sealant. |
| Waterproof | Polyurethane | Manufacturer: Shandong Fanghua |
| adhesive | waterproof | Environmental Protection New |
| | adhesive | Materials Co., Ltd., |
| | | Name: Polyurethane Adhesive. |
| | Acrylic | Manufacturer: Shandong Xinhong |
| | waterproof | Yunguang Chemical Co., Ltd., |
| | adhesive | Name: Acrylic Acid. |
| | Epoxy resin | Manufacturer: Shanghai Kening |
| | waterproof | Waterproof and Anti corrosion |
| | adhesive | Engineering Co., Ltd. |
| | | Name: Epoxy Resin Adhesive. |
| Multifunctional | ZS-533 marine | Manufacturer: Beijing Zhisheng Weihua |
| marine | anti-biological | Chemical Co., Ltd., |
| protective | adhesion | Name: ZS-533 Marine Anti-biological |
| coating | coating | Adhesion Coating. |
| | Organic silicon | Manufacturer: Weifang Jiaoyang |
| | anti-seepage | Waterproof Material Co., Ltd. |
| | coating | Name: Organic Silicon Rubber |
| | | Waterproof Coating. |
| | Silicate | Manufacturer: Shandong Tiantai |
| | polymer | Waterproof Technology Co., Ltd., |
| | coating | Name: JS Polymer Cementitious |
| | | Composite Waterproof Coating. |

| Cement blanket | Manufacturer: Dezhou Runda Plastic |
|---|---|
| | Engineering Co., Ltd., |
| | Name: Cement Blanket |

A first embodiment—a construction method of a square mariculture net cage floating body with 15 m×15 m based on a combination of cement blanket and ECC

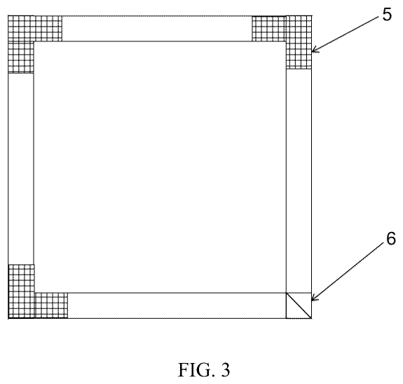

Referring to FIG. 2 and FIG. 3, a production process of the mariculture net cage floating body is as follows.

(1) Cutting cement blanket with a thickness of 20 mm that is purchased into four rectangular cement blanket blocks with a length of 15 m and a width of 2 m, which is prepared for being used; a ϕ600 mm thin PVC pipe 1 is taken as an inner mold, the four cement blanket blocks are rolled around the PVC pipe 1 along a width direction thereof to form a cement blanket layer 2. A bottom layer of the cement blanket with a waterproof adhesive film is attached to the PVC pipe 1 to form a 15 m long cylinder. After coating polymer cement slurry adhesive on joints of the cement blanket, the joints are sewn with PE threads to produce four 15 m long cement blanket pipes. At this time, a thickness of the cement blanket that is wrapped is 20 mm. Two ends of each cement blanket pipe are sealed with a cylinder plugging material that is a 0.5 m long cylindrical polyurethane foam. Contact surfaces between the cylinder plugging material and the cement blanket pipe are bonded with acrylic waterproof adhesive to achieve watertight effect thereof. Cutting the two ends of the cement blanket pipe that is sealed to connect adjacent ends at an angle of 45° to form a right angle thereof, and then connecting the ends of the four cement blanket pipes in sequence to form a substrate of a square net cage floating body. Using silicone waterproof sealant to bond joints of the ends of adjacent cement blanket pipes, sewing the joints of adjacent cement blanket pipes by using the PE thread, and then treating the joints with acrylic waterproof adhesive to form a waterproof sealing connection corner of the cement blanket 6. In this way, a square net cage floating frame is formed.

(2) And then, using a sprayer to spray water on surfaces of the net cage floating body frame to make the cement inside the cement blanket perform hydration reaction on the cement. An amount of water that is sprayed is subject to an amount of the cement blanket that is sprayed on the surfaces of the net cage floating body frame, and accumulated water should be not occurred in the cement blanket to flow out of the cement blanket. Spraying the cement blanket four times in total, and the amount of water is 30% of the cement that is filled inside the cement blanket. After the cement blanket is solidified and hardened, continuing to intermittently sprinkle a small amount of water for keeping maintenance for three days. Afterwards, using a steel wire mesh with a mesh thickness of 5 mm to bundle and wrap four right-angle joints, covering two intersecting ends of the cement blanket with each length of not less than 1 m, to obtain the substrate of the net cage floating body.

(3) Using three-dimensional fabric with a thickness of 5 mm to wrap the above-mentioned substrate of the net cage floating body in a winding manner to form a three-dimensional fabric layer 3 with a thickness of 5 mm. During in the wrapping process, an angle of 35° is maintained between the three-dimensional fabric and a structural length direction of the cement blanket net cage floating body, for ensuring a 10 mm overlap to be formed between adjacent covering layers thereof. And then, the chopped fiber reinforced cement slurry that is prepared is applied to cover the entire cement blanket net cage floating body, to form a chopped fiber reinforced cement slurry layer 4 with a thickness of 2 mm, wherein a thickness of the chopped fiber reinforced cement slurry that covers the steel wire mesh 5 is 4 mm. After the chopped fiber reinforced cement slurry on the surface is solidified and hardened, it is polished to obtain a surface that is basically flat, without adhesive scars or sharp protrusions thereof. Finally, applying ZS-533 marine anti-biological adhesion coating with a thickness of 2 mm to obtain a mariculture net cage floating body based on the combination of the cement blanket and ECC. The chopped fiber reinforced cement slurry is prepared from the following weight parts of raw materials: 50 parts of portland cement, 20 parts of slag powder, 30 parts of first-class fly ash, 60 parts of river sand with a particle size of less than 1.25 mm, 2 parts of dihydrate gypsum, 3 parts of polycarboxylate superplasticizer, 3 parts of chopped basalt fibers with a length of 15 mm, and 30 parts of water.

In addition, the cement blanket can be replaced with UHPC (ultra-high performance concrete) and HDPE (high-density polyethylene) pipes respectively to produce the net cage floating body.

\textcircled{1} A manufacturing process of the UHPC floating body: using a UHPC material to pour four UHPC prefabricated cement pipes with a length of 15 m, a radius of 0.41 m and a wall thickness of 40 mm. A solid part of the UHPC prefabricated cement pipe is reserved with through-holes, and steel bars or steel strands are used to pass through the reserved holes during assembly. Before the net cage is launched into water, sections of the UHPC prefabricated cement pipes are tightly connected together, and then the steel bars are fixed in the holes through a grouting way to form a quadrilateral floating body, and joints are sealed to form the net cage floating body.

\textcircled{2} A manufacturing process of the HDPE floating body: using a commercial HDPE plastic pipe with a radius of 0.25 m and a thickness of 20 mm, bending the pipe to form a circle with a radius of 7.5 m, and using strong adhesive and a hoop to connect two ends of the circle together to form the net cage floating body.

The three types of materials mentioned above are used to produce the net cage floating body, so that a net buoyancy of about 10 tons (i.e. a total buoyancy minus a weight of the structure) is occurred in the net cage floating body. Differences of main parameters of the floating body that is made of the three different materials are compared, and results are shown in Table 1. A volume density of the cement blanket that is hardened here is 2000 kg/m³, a volume density of HDPE is 2100 kg/m³, and a volume density of UHPC is 2500 kg/m³.

TABLE 1
Main structural parameters of net cage floating
bodies with three different material systems

| | Thickness | Radius | | | | | Net |
|---|---|---|---|---|---|---|---|
| | of | of | Continuous | Chopped | Self-weight | | buoyancy |
| | floating | floating | ECC layer | fiber ECC | of floating | | of floating |
| Material | body | body | thickness | thickness | body | | body |
| Cement | 27 mm | 0.32 m | 5 mm | 2 mm | 6165 | kg | 10 tons |
| blanket + | | | | | | | |
| ECC | | | | | | | |
| UHPC | 40 mm | 0.41 m | 0 | 0 | 15957 | kg | 11 tons |
| HDPE | 20 mm | 0.25 m | 0 | 0 | 1760 | kg | 10 tons |

A calculation result shows that under the same bearing capacity (referring to the same or similar load on the net cage floating body when the net cage floating body reaches the same waterline (an underwater depth)), a deadweight of the UHPC structure is nine times that of the HDPE structure, while a deadweight of the cement blanket+ECC structure is 3.5 times that of the HDPE structure. The weight of the floating body has comprehensive advantages of stability, economy and convenience.

A second embodiment—a construction method of a square mariculture net cage floating body with 15 m×10 m based on a combination of cement blanket and ECC

A production process of the mariculture net cage floating body is as follows.

(1) Taking two pieces of wood to process into two ϕ600 mm long side pipes with a length of 15 m, and then taking another two pieces of wood to process into two ϕ600 mm chopped side pipes with a length of 10 m. Then, connecting the two long side pipes and the two chopped side pipes by using mortise and tenon connections in sequence to form a rectangular net cage floating frame. Cutting the cement blanket with a thickness of 15 mm into two long cement blanket blocks with a length of 15 m and a width of 2 m, to wrap around the two long side pipes. Additionally, cutting the cement blanket into two chopped cement blanket blocks with a length of 10 m and a width of 2 m, to wrap around the two chopped side pipes. At this time, the cement blanket is wrapped to form a cement blanket layer of a thickness of 15 mm, a waterproof layer of the cement blanket block is on an inner side thereof, and the polyurethane waterproof adhesive is used to bond between the layers of the cement blanket, and the silicone waterproof sealant is used to seal internal and external connections of the cement blanket. And then, using a sprayer to spray water on each part of the cement blanket wrapping body to make the cement inside the cement blanket perform hydration reaction on the cement. An amount of water that is sprayed is subject to an amount of the cement blanket that is sprayed on the surfaces of the net cage floating body frame, and accumulated water should be not occurred in the cement blanket to flow out of the cement blanket. Spraying the cement blanket four times in total, and the amount of water is 25% of the cement that is filled inside the cement blanket. After the cement blanket is solidified and hardened, continuing to intermittently sprinkle a small amount of water for keeping maintenance for three days. Afterwards, using a steel wire mesh with a mesh thickness of 5 mm to bundle and wrap four right-angle joints, covering two intersecting ends of the cement blanket with each length of not less than 1 m, to obtain the substrate of the net cage floating body.

(2) Using a three-dimensional fabric with a thickness of 10 mm to wrap the above-mentioned net cage floating body in a winding manner to form a three-dimensional fabric layer with a thickness of 10 mm. During in the wrapping process, an angle of 60° is maintained between the three-dimensional fabric and a structural length direction of the cement blanket net cage floating body, for ensuring a 15 mm overlap to be formed between adjacent covering layers. And then, the chopped fiber reinforced cement slurry that is prepared is sprayed to cover the entire cement blanket net cage floating body, a thickness of a chopped fiber reinforced cement slurry layer is 3 mm, wherein a thickness of the chopped fiber reinforced cement slurry that covers the steel wire mesh is 4 mm. After the chopped fiber reinforced cement slurry on the surface is solidified and hardened, it is polished to obtain a surface that is basically flat, without adhesive scars or sharp protrusions thereof. Finally, applying silicate polymer coating with a thickness of 2 mm to obtain a mariculture net cage floating body based on the combination of the cement blanket and ECC. The chopped fiber reinforced cement slurry is prepared from the following weight parts of raw materials: 40 parts of portland cement, 15 parts of slag powder, 35 parts of first-class fly ash, 80 parts of river sand with a particle size of less than 1.25 mm, 3 parts of dihydrate gypsum, 1 part of polycarboxylate superplasticizer, 3 parts of chopped PE fibers with a length of 12 mm, and 30 parts of water.

A third embodiment—a construction method of a circular mariculture net cage floating body with 7.5 m based on a combination of cement blanket and ECC

(1) Processing a rubber airbag into a circular airbag with a radius of 7.5 m to form a circular net cage floating frame, cutting the cement blanket with a thickness of 10 mm into two rectangular cement blankets with a length of 47 m and a width of 2 m, to wrap around the circular net cage floating frame to form multiple layers of wrapping, and form a cement blanket layer with a thickness of 20 mm. A waterproof layer of the two cement blankets is located on an inner side thereof, and then acrylic waterproof adhesive is used to bond between the layers of the cement blanket, and the silicone waterproof sealant is used to seal internal and external connections of the cement blanket. And then, using a sprayer to spray water on each part of the cement blanket wrapping body to make the cement inside the cement blanket perform hydration reaction on the cement. An amount of water that is sprayed is subject to an amount of the cement blanket that is sprayed on the surfaces of the net cage floating body frame, and accumulated water should be not occurred in the cement blanket to flow out of the cement blanket. Spraying the cement blanket twice in total, and the amount of water is 35% of the cement that is filled inside the cement blanket. After the cement blanket is solidified and hardened, continuing to intermittently sprinkle a small amount of water for keeping maintenance for three days, to obtain the substrate of the net cage floating body.

(2) Using a three-dimensional fabric with a thickness of 3 mm to wrap around the net cage floating body to form a three-dimensional fabric layer with a thickness of 3 mm. During in the wrapping process, an angle of 45° is maintained between the three-dimensional fabric and a structural length direction of the cement blanket net cage floating body, for ensuring a 20 mm overlap to be formed between adjacent covering layers. And then, the chopped fiber reinforced cement slurry that is prepared is applied to cover the entire cement blanket net cage floating body, and a thickness of a chopped fiber reinforced cement slurry layer is 5 mm, wherein a thickness of the chopped fiber reinforced cement slurry that covers the steel wire mesh is 4 mm. After the chopped fiber reinforced cement slurry on the surface is solidified and hardened, it is polished to obtain a surface that is basically flat, without adhesive scars or sharp protrusions thereof. Finally, applying organic silicon anti-seepage coating with a thickness of 2 mm to obtain a mariculture net cage floating body based on the combination of the cement blanket and ECC. The chopped fiber reinforced cement slurry is prepared from the following weight parts of raw materials: 60 parts of portland cement, 25 parts of slag powder, 25 parts of first-class fly ash, 70 parts of river sand with a particle size of less than 1.25 mm, 1 part of dihydrate gypsum, 2 parts of polycarboxylate superplasticizer, 1 part of chopped fibers with a length of 14 mm that is composed of PVA fiber and basalt fiber in a mass ratio of 1:1, and 30 parts of water.

### A First Comparative Example

The first comparative example is adjusted based on the first embodiment of the present disclosure, without using the cement blanket to wrap around the PVC pipe. Instead, the PVC pipe is directly used to build the substrate of the net cage floating body, and then the three-dimensional fabric is directly used to wrap around the substrate of the net cage floating body, that is, without performing the steps (1) and (2) of the first embodiment of the present disclosure. A specific process is as follows.

(1) Cutting a φ600 mm thin PVC pipe 1 into four pipes with a length of 15 m that are taken as an internal mold. A cylinder plugging material of a cylindrical polyurethane foam with a length of 0.5 m is used for performing plugging operation on both ends of each pipe, and using acrylic waterproof adhesive to bond contact surfaces between the cylinder plugging material and the pipe, to obtain a water tightness effect thereof. Cutting ends of the pipes that are plugged so that adjacent ends are connected at an angle of 45° to form a right angle thereof. And then, connecting the ends of the four pipes in sequence to form a net cage frame. Using silicone waterproof sealant to bond end connections of adjacent pipes, sewing joints with PE threads, and treating the joints with acrylic waterproof adhesive to obtain a substrate of a square net cage floating body.

### A Second Comparative Example

The second comparative example is adjusted the preparation process of step (3) based on the first embodiment of the present disclosure, lacking the process of using the three-dimensional fabric to wrap, and is directly applied the chopped fiber reinforced cement slurry that is prepared. A specific process is as follows.

(3) The chopped fiber reinforced cement slurry that is prepared is applied to cover the entire cement blanket net cage floating body, to form a chopped fiber reinforced cement slurry layer 4 with a thickness of 2 mm, wherein a thickness of the chopped fiber reinforced cement slurry that covers the steel wire mesh 5 is 4 mm. After the chopped fiber reinforced cement slurry on the surface is solidified and hardened, it is polished to obtain a surface that is basically flat, without adhesive scars or sharp protrusions thereof. Finally, applying ZS-533 marine anti-biological adhesion coating with a thickness of 2 mm to obtain a mariculture net cage floating body based on the combination of the cement blanket and ECC. The chopped fiber reinforced cement slurry is prepared from the following weight parts of raw materials: 50 parts of portland cement, 20 parts of slag powder, 30 parts of first-class fly ash, 60 parts of river sand with a particle size of less than 1.25 mm, 2 parts of dihydrate gypsum, 3 parts of polycarboxylate superplasticizer, 3 parts of chopped basalt fibers with a length of 15 mm, and 30 parts of water.

### A Third Comparative Example

The third comparative example is adjusted the preparation process of step (3) based on the first embodiment of the present disclosure, after wrapping the three-dimensional fabric, without applying the chopped fiber reinforced cement slurry. A specific process is as follows.

(3) Using a three-dimensional fabric with a thickness of 5 mm to wrap around the substrate of the net cage floating body to form a three-dimensional fabric layer 3 with a thickness of 5 mm. During in the wrapping process, an angle of 35° is maintained between the three-dimensional fabric and a structural length direction of the cement blanket net cage floating body, for ensuring a 10 mm overlap to be formed between adjacent covering layers. In this way, a mariculture net cage floating body based on the combination of the cement blanket and ECC is obtained.

### A Fourth Comparative Example

On the basis of the first embodiment of the present disclosure, in the fourth comparative example, the raw material ratio of the chopped fiber reinforced cement slurry is adjusted, which is specifically as follows: the chopped fiber reinforced cement slurry includes the following weight parts of raw materials: 60 parts portland cement, 10 parts slag powder, 40 parts first-class fly ash, 45 parts of river sand with a particle size of less than 1.25 mm, 8 parts of dihydrate gypsum, 1 part polycarboxylate superplasticizer, 10 parts of chopped fibers, and 30 parts of water.

In addition, the substrate of the net cage floating body that is prepared by the methods of the second embodiment and the third embodiment of the present disclosure also has good stability, can effectively resist impact of winds and waves, and achieve good compactness and anti-corrosion performances thereof, thereby effectively improving the service life of the net cage. Moreover, replacing the wood of the second embodiment with a bamboo of a corresponding size can also achieve a good result. Compared with the first embodiment, the mariculture net cage floating body that is prepared by the methods of the first comparative example to the fourth comparative example has poor impact ability to resist wind and waves, require frequent maintenance, has poor stability, and has a shorter service life than the net cage floating body that is prepared by the method of the first embodiment of the present disclosure. The method of the first embodiment does not contain a cement blanket component, that is a main structural load-bearing layer and a main buoyancy provider. If there is no cement blanket, the deadweight of the net cage floating body is reduced, so that it is easier to be shaken by waves, thereby reducing its ability to resist to wind and wave impacts. The second comparative example lacks the wrapping of the three-dimensional fabric. Because a fact that the cement blanket is directly wrapped around the floating material, a lack of three-dimensional fabric protection for the cement blanket results in that the cement blanket is direct in contact with seawater, so that the gaps that exist during wrapping the cement blanket are easily dispersed, leading to an incomplete structure of the net cage floating body, a poor anti-seepage sealing performance, and also affecting mechanical properties of the net cage floating body. In the third comparative example, without spraying or applying the chopped fiber reinforced cement slurry, so that the three-dimensional fabric is easily exposed to the outside and easily prone to being aged and failed under an action of ultraviolet rays, thereby reducing the service life of the entire net cage floating body. In addition, in the fourth comparative example, a composition ratio of each raw material is changed, so that the chopped fiber-reinforced cement slurry is also affected to protect the three-dimensional fabric. Finally, adding the chopped fibers to the chopped fiber reinforced cement slurry can effectively prevent the surface cement from cracking and peeling, thereby improving the performance of the entire net cage floating body and extending the service life of the entire net cage floating body.

In summary, the present disclosure is provided that the cement blanket, the three-dimensional fabric and the chopped fiber reinforced cement slurry are combined to form a multi-layer composite material, which improves an overall stiffness, toughness, and sealing of the net cage floating body, and also enhances the service life of the net cage floating body.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A construction method of a mariculture net cage floating body based on a combination of cement blanket and ECC comprising:
step S1, combining cement blanket with a floating material to build a net cage floating frame, sealing internal and external connections of the cement blanket by adopting waterproof sealant, and then spraying water on surfaces of the net cage floating frame to enable cement in the cement blanket to generate hydration reaction, to obtain a substrate of the net cage floating body;
step S2, wrapping continuous three-dimensional fabric around an outer surface of the substrate of the net cage floating body that is obtained in the step S1, and then applying or spraying chopped fiber reinforced cement slurry on surfaces of the wrapped continuous three-dimensional fabric, wherein after the chopped fiber reinforced cement slurry is solidified, polishing the surface of the net cage floating body and then applying multifunctional marine protective coating, to obtain the marine aquaculture net cage floating body based on the combination of cement blanket and ECC, wherein the ECC refers to the chopped fiber reinforced cement slurry; and wherein
the chopped fiber reinforced cement slurry is prepared from the following weight parts of raw materials: 40-60 parts of portland cement, 15-25 parts of slag powder, 25-35 parts of fly ash, 60-80 parts of river sand, 1-3 parts of dihydrate gypsum, 1-3 parts of polycarboxylate superplasticizer, 1-4 parts of chopped fibers, and 20-40 parts of water; and wherein the chopped fibers comprise one or more of PVA fiber, PE fiber and basalt fiber, a length of the chopped fiber is 12-15 mm, the portland cement is P.I Portland cement, the fly ash is first-class fly ash, and a particle size of the river sand is smaller than or equal to 1.25 mm.

2. The construction method as claimed in claim 1, wherein the floating material is selected from one of a PVC pipe, a bamboo, a wood and a rubber airbag, and the waterproof sealant is a silicone waterproof sealant.

3. The construction method as claimed in claim 1, wherein the construction method further comprises a plurality of layers of cement blanket is used to wrap the floating material, and a waterproof adhesive is used to bond between the layers of the cement blanket, and a thickness of the floating material that is wrapped by the cement blanket is 10-20 mm.

4. The construction method as claimed in claim 3, wherein the waterproof adhesive is selected from one of a polyurethane waterproof adhesive, an acrylic waterproof adhesive and an epoxy resin waterproof adhesive.

5. The construction method as claimed in claim 1, wherein an amount that water is sprayed during a spraying process is based on that the cement blanket is fully wet on the surfaces of the net cage floating frame, the water is sprayed twice or more times, and an amount of water that is sprayed is 25% to 35% of the cement that is filled in the cement blanket.

6. The construction method as claimed in claim 1, wherein the continuous three-dimensional fabric is wrapped around the substrate of the net cage floating body through a winding way, so that a covering layer that is formed by the continuous three-dimensional fabric is tightly bonded to the outer surface of the substrate of the net cage floating body, and there is an overlap width of 10-20 mm between adjacent wrapping layers of the continuous three-dimensional fabric, wherein a thickness of the continuous three-dimensional fabric that is formed on the outer surface of the substrate of the net cage floating body is 3-10 mm.

7. The construction method as claimed in claim 1, wherein a thickness that is formed by applying or spraying the chopped fiber reinforced cement slurry is 2-5 mm.

8. The construction method as claimed in claim 1, wherein a thickness of the multifunctional marine protective coating that is applied to the surface of the net cage floating body is 2-4 mm, and the multifunctional marine protective coating is selected from one or more of ZS-533 marine anti-biological adhesion coating, organic silicon anti-seepage coating, and silicate polymer coating.
